(19) United States
(12) Patent Application Publication
(10) Pub. No.: US 2012/0280909 A1
(43) Pub. Date: Nov. 8, 2012

(54) IMAGE DISPLAY SYSTEM AND IMAGE DISPLAY METHOD

(76) Inventor: Hideki SUGIMOTO, Kanagawa (JP)

(21) Appl. No.: 13/459,966

(22) Filed: Apr. 30, 2012

(30) Foreign Application Priority Data
May 2, 2011 (JP) 2011-102717

(51) Int. Cl. G06F 3/033

(52) U.S. Cl. 345/158

(57) ABSTRACT

An image display system includes an image projection unit that projects image information; a light pointer that designates a point in the image information by irradiating pointing light, wherein the irradiation of the pointing light can be turned on and turned off; a photographing unit that photographs an area on which the image information is projected, and that outputs photographed information; an instruction detection unit that detects an irradiation position of the pointing light in the image information based on the photographed information, and that detects whether the irradiation of the pointing light is turned on or turned off; and a control unit that sets additional image information at a timing in which the instruction detection unit detects that the irradiation of the pointing light is turned off, depending on a position at which the irradiation of the pointing light is turned off.

### BACKGROUND OF THE INVENTION

1. Field of the Invention

Embodiments of the present invention relate to an image display system and an image display method. Specifically, the embodiments relate to an image display system and an image display method that are suitable for improving operability of various operations through a light pointer.

2. Description of the Related Art

For a presentation using a projector, a light pointer, such as a laser pointer, may be utilized for irradiating a desired point on an image projected on a screen. Conventionally, the light pointer only has a function to designate a desired point on a screen, and does not have a usual function to operate a PC and a click function of a mouse.

Accordingly, after an operator designates a desired point by the light pointer, in order to operate a keyboard or a mouse of the PC, which is connected to a projector, the operator may be required to stop designating the point by the light pointer, prior to operating the keyboard or the mouse.

On the other hand, a technique for designating a coordinate or performing a click using the light pointer has been proposed. In the technique, an image projected by a projector is photographed by a camera, and a luminous point of pointing light irradiated from the light pointer on the projected image is detected, and the coordinates are designated or an operation, such as a click, is performed. In such a technique, the click function (the so-called “left click operation”) is realized, for example, by pointing at a point for a defined period of time, or by blinking the light pointer at a predetermined point.

For example, Patent Document 1 (Japanese Published Unexamined Application No. H03-167621) and Patent Document 2 (Japanese Published Unexamined Application No. H04-324847) disclose methods of obtaining position information of a point on a projected image, so as to operate on the projected image by a light pointer. In the methods, the projected image including the point pointed at by the light pointer is photographed by a camera, and the position information of the point on the projected image is obtained by detecting coordinates of the point.

Additionally, Patent Document 3 (Japanese Published Unexamined Application No. 2002-116878) discloses a method of performing a designation operation, such as a click, using a light pointer. In the method, it is determined whether coordinates of a position pointed at by the light pointer immediately before the light pointer is turned off and a coordinate of a position pointed by the light pointer immediately after the light pointer is turned on again are within a predefined range, so as to perform the designation operation with the light pointer.

However, unlike a mouse or the like, for a light pointer, it is difficult to keep designating a same point. Therefore, for a method which may require pointing at a same point for more than a predetermined time period, the operation may be difficult for an operator. Moreover, the operator is required to wait for the predetermined time period, each time the operation is performed. Thus the operation speed is decreased and the operability is lowered.

Further, for the method of performing an operation by blinking the light pointer, the operator is required to press and release an operation switch of the light pointer. In such a case, there is a problem that, when the operator presses the operation switch of the light pointer so as to turn on the light pointer again, the coordinates may be shifted by the movement of a hand and an incorrect operation may be performed. Further, in order to prevent such an incorrect operation caused by the movement of the hand, it may be required to enlarge a range in which the blinking is effective. However, there is another problem that, since the range in which the blinking is effective is unclear to the operator, the operability is lowered.

Further, with the above described method, a single operation, such as a click, may be performed. However, it is difficult to perform other operations, such as the right click operation or a scroll operation (an operation to continue clicking). In some cases, various types of operation buttons (e.g., a scroll button) are displayed on the projected image. However, these operation buttons are so small that it is difficult for them to be accurately designated using the light pointer.

### SUMMARY OF THE INVENTION

An objective of the embodiments is to provide an image display system and an image display method. In the image display system and the image display method, additional images that enable corresponding operations are displayed on a projected image while using an operation to turn off a light pointer as a trigger. With such a configuration, various operations can be accurately performed by using the light pointer, and the operability is improved.

In one aspect, there is provided an image display system including an image projection unit that projects image information; a light pointer that designates a point in the image information by irradiating pointing light, wherein the irradiation of the pointing light can be turned on and turned off; a photographing unit that photographs an area on which the image information is projected, and that outputs photographed information; an instruction detection unit that detects an irradiation position of the pointing light in the image information based on the photographed information, and that detects whether the irradiation of the pointing light is turned on or turned off; and a control unit that sets additional image information at a timing in which the instruction detection unit detects that the irradiation of the pointing light is turned off, depending on a position at which the irradiation of the pointing light is turned off.

In another aspect, there is provided an image display method including an image projection step of projecting image information; a pointing step, by a light pointer, wherein the light pointer designates a point in the image information by irradiating pointing light, and the irradiation of the pointing light can be turned on and turned off; a photographing step of photographing an area on which the image information is projected, and outputting photographed information; an instruction detecting step of detecting an irradiation position of the pointing light in the image information based on the photographed information, and detecting whether the irradiation of the pointing light is turned on or turned off; and a display control step of setting additional image information at a timing in which the instruction detection step detects that the irradiation of the pointing light is turned off, depending on a position at which the irradiation of the pointing light is turned off.

According to the embodiments, the various operations can be accurately and easily performed by using the light pointer.

Other objects, features and advantages of the present invention will become more apparent from the following detailed description when read in conjunction with the accompanying drawings.

### BRIEF DESCRIPTION OF THE DRAWINGS

FIG. 1 is a schematic configuration diagram of an image display system according to an embodiment;

FIG. 2 is a functional block diagram of an input device;

FIGS. 3A and 3B are schematic diagrams showing an example of a display of a selection area;

FIG. 4 is a schematic configuration diagram of the image display system in a state in which the selection areas are displayed;

FIG. 5 is a flowchart showing an example of a displaying operation of the selection areas and operational processing by the input device;

FIG. 6 is a schematic diagram showing another example of the indication of the selection areas;

FIG. 7 is a schematic diagram showing another example of the indication of the selection areas;

FIG. 8 is a schematic diagram showing another example of the indication of the selection areas;

FIG. 9 is a schematic diagram showing an area in an image display area on which the selection areas are not displayed; and

FIG. 10 is a flowchart showing another example of a displaying operation of the selection areas and operational processing by the input device.

### DETAILED DESCRIPTION OF THE PREFERRED EMBODIMENTS

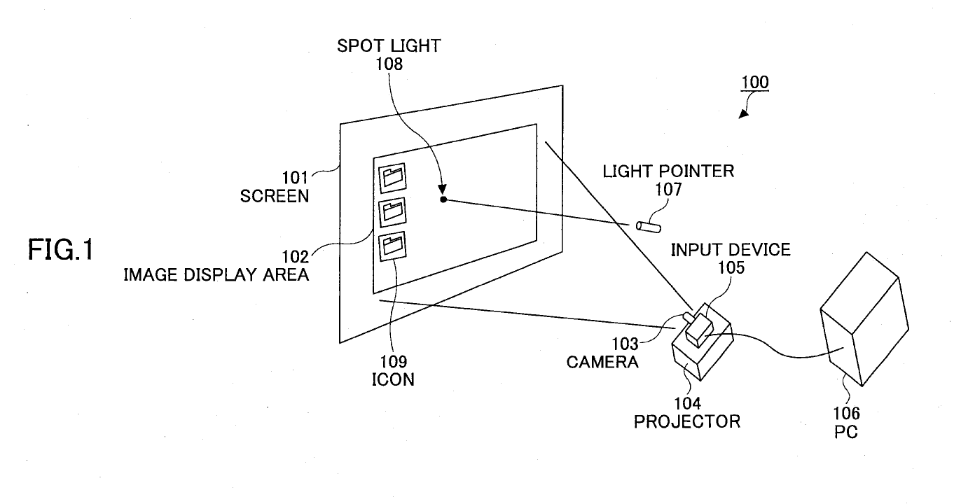

Hereinafter, configurations according to embodiments of the present invention are explained based on FIG. 1 through FIG. 10.

### First Embodiment

An image display system (100) according to a first embodiment includes an image projection unit (projector 104); a light pointer (107); a photographing unit (camera 103); an instruction detection unit (such as a pointer position detection unit 202 of an input device 105); and a control unit (such as a control unit 203 of the input device 105). The image projection unit (projector 104) is for projecting image information (an image projected onto an image display area 102 of a screen 101). The light pointer (107) can indicate a position by irradiating pointing light (spot light 108) onto the image information, and can turn on or turn off the irradiation. The photographing unit (camera 103) photographs an area on which the image information is projected (the image display area 102), and outputs the photographed information. The instruction detection unit (a pointer position detection unit 202 of the input device 105) detects an irradiation position of the pointing light on the image information based on the photographed information, and detects on/off state of the irradiation of the pointing light. The control unit sets additional image information (such as a selection area 306) depending on a position at which the pointing light is turned off, when the instruction detection unit detects that the irradiation of the pointing light is turned off.

Namely, for the first embodiment, it is focused on that a motion of spot light caused by a motion of a hand at a time period in which the light pointer is turned off is smaller than a motion of the spot light at a time period in which the light pointer is turned on. Operability of the image displaying system 100 is improved by displaying the selection area that indicates plural operations while utilizing an operation to turn off the light pointer as a trigger. For example, in a selection area indicating desired operations, by turning off and subsequently turning on the light pointer again, not only a normal click operation (left click), but also plural operations including, for example, a right click and a scroll can be selected from a visual display image.

(Outline of the Image Display System)

FIG. 1 is a schematic configuration diagram of the image display system 100 according to the first embodiment. Basic operations of the image display system 100 are explained by referring FIG. 1.

FIG. 1 shows a state in which a projector 104 arranged substantially in front of a screen 101 projects a predetermined image (image information) for a presentation. In this case, an operator can make a presentation to a third party while designating a desired position in an image display area 102, which is an area within the screen 101 on which an image is being displayed, by the light pointer 107, such as a laser pointer.

Further, when the operator designates the desired position on the image display area 102 using spot light 108 irradiated from the light pointer 107, the image display area 102 and the spot light 108 are photographed by a camera 103 arranged substantially in front of the image display area 102 as an instruction image.

Image processing, such as a centroid detection process, is performed on the instruction image at the input device 105, and the position of the geometric center of the spot light 108 is detected as an instruction position (pointer position). By transmitting operation information to a PC 106 depending on the instruction position and/or whether the spot light 108 is detected, operations, such as movement of a cursor or a left click or a right click of an icon 109, are realized.

In the image display system 100 indicated in FIG. 1, the projector 104, the camera 103, and input device 105 are realized as different hardware items. However, the image display system 100 may have a configuration such that the projector 104 includes the camera 102 and/or the input device 105. For example, the image display system 100 may include the projector 104 including the camera 103 and the input device 105, and the PC 106.

Further, in the example shown in FIG. 1, the projector 104 and the camera 103 are arranged substantially in front of the screen 101, but the projection position and the photographing position are not limited to this. For example, the instruction position may be detected by using a close range projector 104 that can project an image at a close range substantially in the horizontal direction and by correcting the projection position.

(Configuration of Input Device)

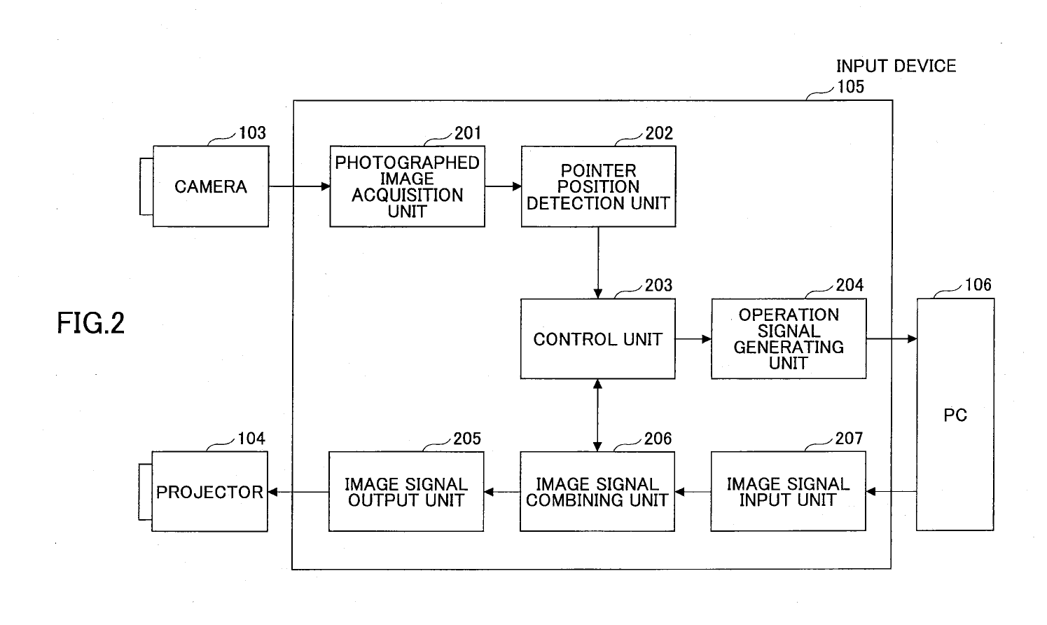

FIG. 2 shows a functional block diagram of the input device 105. Here, the input device 105 may be realized by a hardware resource, which is different from that of the PC 106. Alternatively, the input device 105 may be included in the PC 106 as hardware. Additionally, the input device 105 may be realized by causing the PC 106 to function as the input device 105 by executing a program. In this case, the camera 103 and the projector 104 may be directly connected to the PC 106.

First, the input device 105 obtains the instruction image through a photographed image acquisition unit 201. Here, the instruction image is an image of the image display area 102 and the spot light 108, which is photographed by the camera 103.

The pointer position detection unit 202 detects, for the instruction image, the instruction position that is the position of the geometric center of the spot light 108. The instruction position in the instruction image may be detected by a known method or a novel method, and the detection method is not particularly limited. For example, the instruction position in the instruction image may be detected by a noise filtering process, a binarizing process, and a centroid detection process. The coordinates of the instruction position detected in such a way are transmitted to a control unit 203.

Further, an image signal input unit 207 receives an image signal from the PC 106, and transmits the image signal to an image signal combining unit 206. The image signal combining unit 206 transmits an image size of the input image signal to the control unit 203.

The control unit 203 performs a coordinate transformation based on the coordinate data on the camera 103 from the pointer position detection unit 202 and the image size received from the image signal combining unit 206, and the coordinate data is converted into the coordinates of an image on the PC 106 and transmitted to an operation signal generating unit 204. The operation signal generating unit 204 generates an operation signal that can be recognized by the PC 106, such as a signal equivalent to the signal generated by a USB mouse, and transmits the generated operation signal to the PC 106.

With the above described operations, the designation of the instruction position by the light pointer 107 can be realized.

Further, the control unit 203 can calculate a trajectory of the change of the instruction position based on the coordinate data detected by the pointer position detection unit 202, and calculate a variation (a motion vector) of the instruction position based on the trajectory of the change of the instruction position. With these, a motion trajectory and a moving velocity of the spot light 108 from the light pointer 107 may be obtained. Here, the above processes may be performed by the PC 106.

Further, when the light pointer 107 is turned off, the pointer position detection unit 202 notifies the control unit 203 of no detection of the coordinates of the light pointer 107. When the control unit 203 detects that the light pointer 107 is turned off, the control unit 203 transmits the coordinate position of the spot light 108 existing prior to turning off the light pointer 107, together with images corresponding to the selection area 306 indicating plural contents of instructions (operating instructions, such as the left click, the right click, and the scrolling) to the image signal combining unit 206. The image signal combining unit 206 combines these images with the image input from the PC 106.

Then the image signal combining unit 206 transmits the combined image to an image signal output unit 205, as an image input signal to be input to the projector 104. In this manner, an image is projected from the projector 104. Here, in the projected image, the selection area is combined with the image input from the PC 106.

When an operator turns on the light pointer 107 again while pointing at a selection button included in the selection area in the projected combined image and the control unit 203 receives the coordinates of the selection button, the control unit 203 transmits an instruction to the operation signal generating unit 204. Here, the instruction represents an operation corresponding to the selection button.

With the above described operations, the selection area can be displayed and operated while the operation to turn off the light pointer 107 is utilized as a trigger.

(Display and Operation of Selection Area)

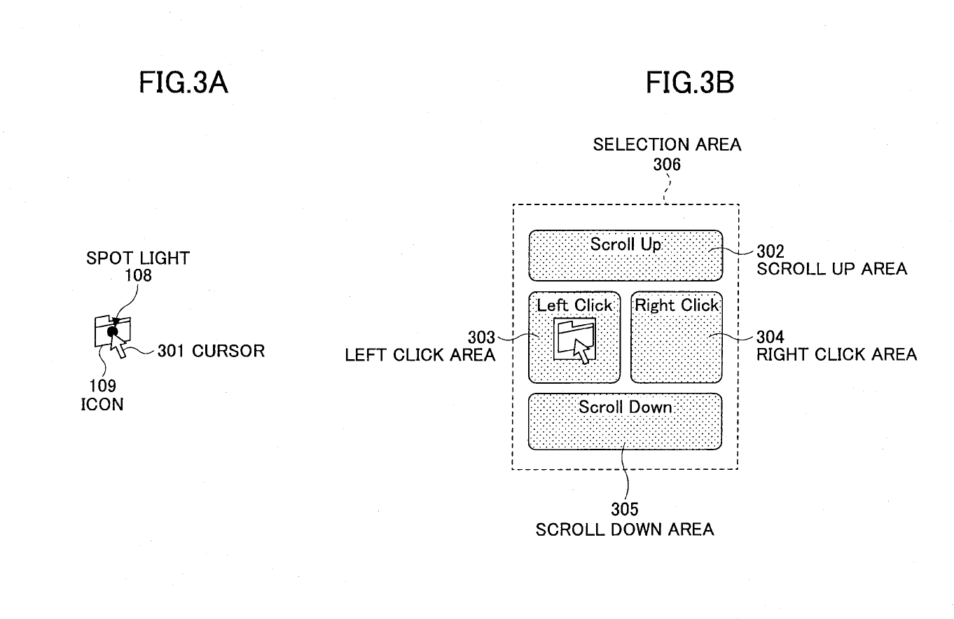

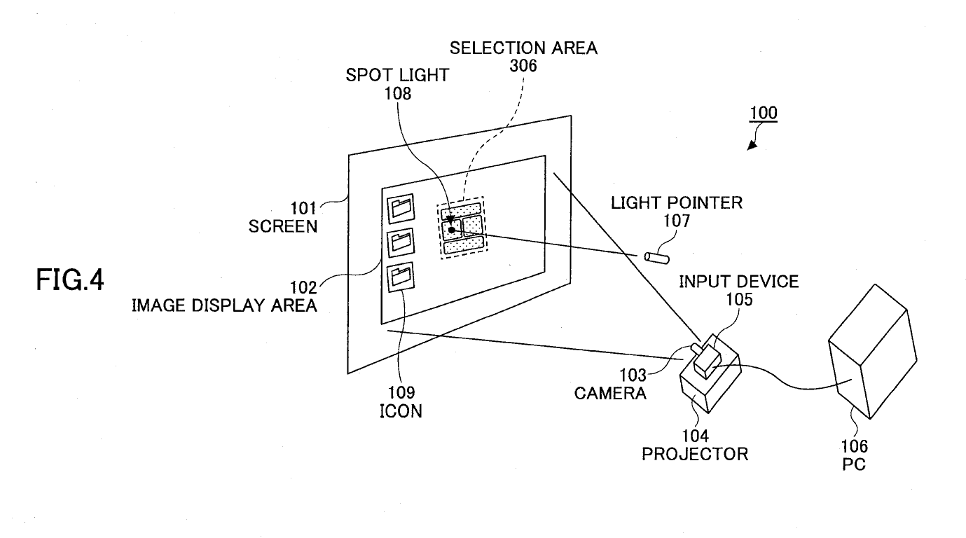

The above operations are explained by referring to an example of a display of the selection area shown in FIG. 3B. As shown in FIG. 3A, when the spot light 108 is turned off at a predetermined position (on an icon 109, in FIG. 3A) by turning off the light pointer 107, the selection area 306 is overlaid on the original image, as shown in FIG. 3B, while the position at which the spot light 108 has been turned off (the position of the icon 109) is utilized as a reference position. FIG. 4 is a schematic diagram of the image display system in a state in which the selection area 306 is combined with the image display area 102 and displayed.

In the example shown in FIG. 3B, the selection area 306 includes 4 areas (operation buttons), which are a scroll up area 302, a left click area 303, a right click area 304, and a scroll down area 305. When the spot light 108 from the light pointer 107 is turned on again at a predetermined position in the selection area 306, a selection operation (click operation) for selecting one of the areas 302 through 305 corresponding to the predetermined position is executed, and a corresponding operation signal is output. By displaying the operation buttons for executing the corresponding operations on the selection area 306 as a group, so that the operation buttons can be easily seen, any of the areas 302 through 305 may be easily irradiated by the spot light 108, even if the light pointer 107 is utilized. In this manner, operability of the image display system can be improved.

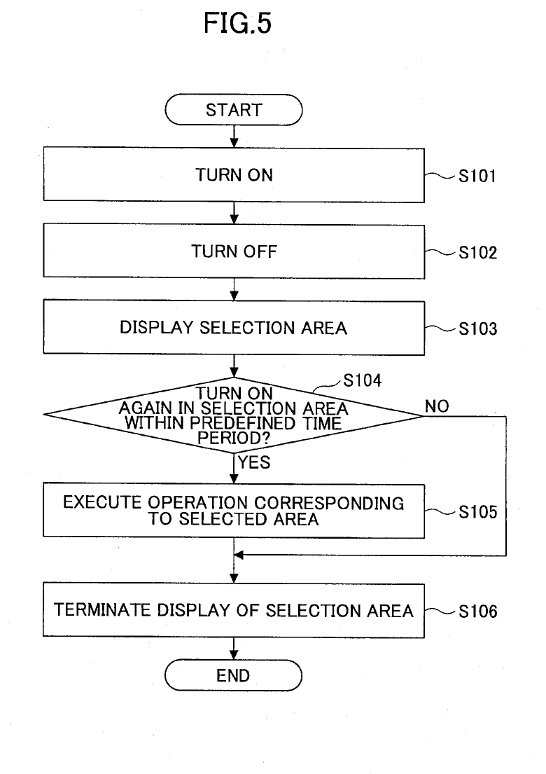

Further, the above described display and operation processing of the selection areas by the input device 105 are shown in the flowchart of FIG. 5.

First, when the control unit 203 of the input device 105 is detecting that the light pointer 107 is turned on (S101) and subsequently detects that the light pointer 107 is turned off (S102), the control unit 203 of the input device 105 combines the selection area with the original image, and the combined image is projected (S103).

In this state, the control unit 203 of the input device 105 determines whether the spot light 108 from the light pointer 107 is turned on again in the selection area 306 within a predefined time period (S104). When the control unit 203 of the input device 105 determines that the spot light 108 is turned on in the selection area 306 (S104: Yes), the operation corresponding to the selection button designated by the spot light 108 is executed (S105). Then the display of the selection area 306 is terminated (S106).

On the other hand, when the light pointer 107 is not turned on again for the predefined time period or the spot light 108 from the light pointer 107 is turned on to irradiate a position outside the selection area 306 (S104: No), the display of the selection area 306 is terminated (S106).

Here, the shape of the selection area 306 and the types of the operation buttons in the selection area 306 are not limited to the example shown in FIG. 3B. For example, it is preferable that the size and the shape of the selection area 306, the size, the shape, and the position of each of the operation buttons, and an operation corresponding to each of the operation buttons be arbitrary set. Further, it is preferable that a desired display style be selectable among plural display styles of the selection area, which have been registered in advance.

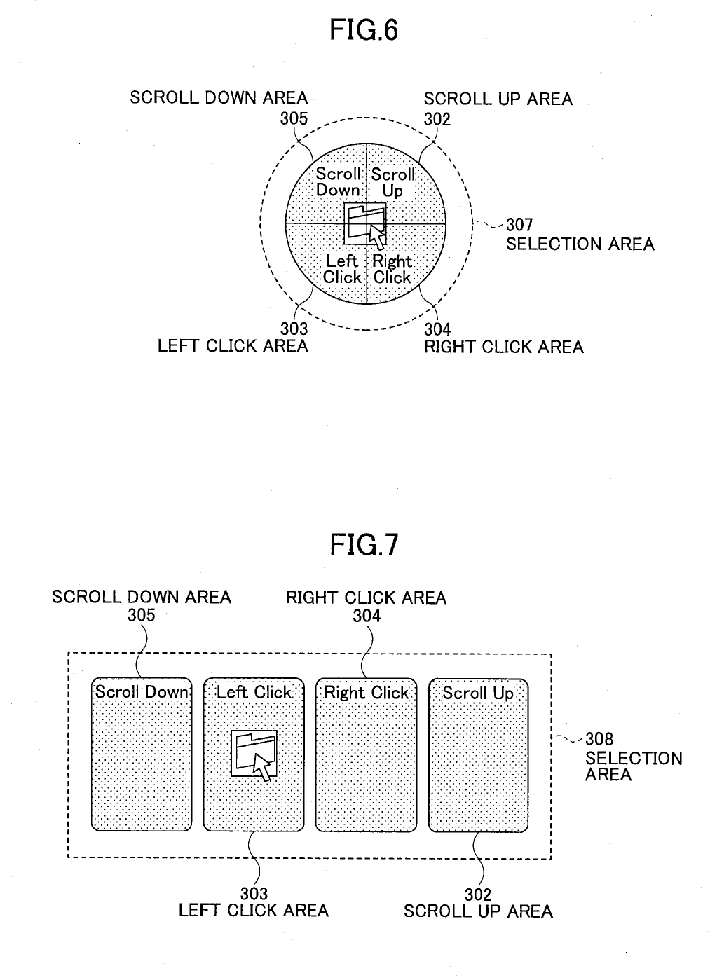

For example, a selection area 307 as shown in FIG. 6 is preferable. Here, the selection area 307 is centered on a point (the icon 109) at which the spot light 108 from the light pointer 107 is turned off, and the selection buttons 302 through 305 are arranged within the selection area 307 concentrically. In such a case, moving amounts of the spot light 108 for selecting the corresponding selection buttons 302 through 305, after the light pointer 107 is turned off, are substantially the same.

Further, for example, if the motion of the hand in the horizontal direction is greater, because of the position or the shape of the switch of the light pointer 107, a selection area 308 in which the selection buttons 302 through 305 are arranged in the vertical direction, as shown in FIG. 7, is preferable.

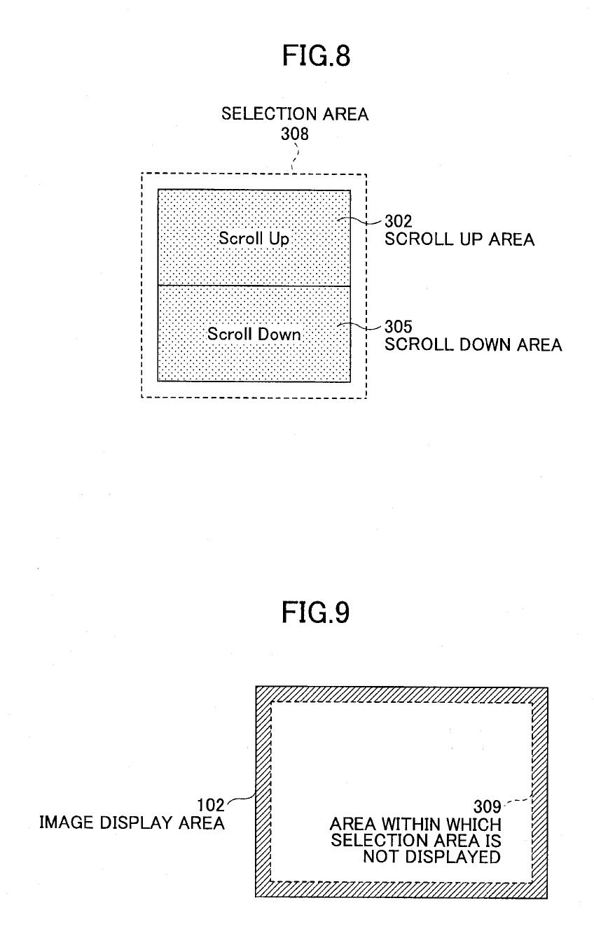

Further, for example, if only the scroll up and the scroll down are utilized, such as a case in which a document or a figure is merely read, a selection area 310 shown in FIG. 8, which only includes the scroll up area 302 and the scroll down area 305, may be utilized.

Further, the selection area may not be overlaid on the position at which the spot light 108 from the light pointer 107 is turned off. For example, the selection area may be displayed in the vicinity of the position (the position of the icon 109) at which the spot light 108 is turned off.

Further, for example, when the operator moves the spot light 108 toward outside the image display area 102, it is detected as if the spot light 108 were turned off, even if the spot light 108 is not turned off for a particular operation. Thus, as shown in FIG. 9, an area (boundary region) 309, within which the selection area 306 is not displayed, may be defined at portions close to the edge portions of the image display area 102. Here, even if it is detected in the area 309 that the spot light 108 from the light pointer 107 is turned off, the selection area 306 is not displayed. In this manner, it can be prevented that the selection area 306 is unintentionally displayed.

As explained above, when the light pointer 107 is turned off, the operation to turn off the light pointer 107 is an operation to release the lighting switch. Thus the hand is not shaken. Therefore, with the image display system 100 according to the first embodiment, the operator can designate desired coordinates by turning off the light pointer 107. Further, the selection area indicating plural operations is displayed while the operation to turn off the light pointer 107 is utilized as a trigger. Therefore, the plural operations can be realized.

Further, when a desired operation is performed by turning on the light pointer 107 again, the operation to turn on the light pointer 107 is an operation to press the lighting switch. Thus the hand tends to be shaken. However, an incorrect operation caused by the movement of the hand may be prevented by displaying the selection area, which is wider than a range of the movement of the spot light 108 caused by the movement of the hand. Further, when the desired operation is performed by turning on the light pointer 107 again, the operator may turn on the light pointer 107 while directing the light pointer 107 to the selection area 306, which is visible. Thus the operator can perform a clear operation. Moreover, for each of the plural operations, the operator can operate without waiting for a predefined time period, and the operation time can be reduced. In this manner, various types of operations can be accurately and easily executed by using the light pointer 107.

### Second Embodiment

Hereinafter, the image display system according to a second embodiment is explained. Here, explanations of the second embodiment which are common to those of the first embodiment are appropriately omitted.

In the first embodiment, when the light pointer 107 is turned off, the selection area 306 is displayed. The operation corresponding to a particular selection button in the selection area 306 is executed, when the point at which the spot light 108 is turned off is placed within the particular selection button. However, when the light pointer 107 is moved after the light pointer 107 is turned off, or when the light pointer 107 is temporarily released, it is difficult to align the position of the spot light 108 from the light pointer 107. Thus the spot light 108 may not be turned on again at the operator's desired position, and it is possible that an unintended operation is performed.

Therefore, the operation corresponding to the point at which the spot light 108 is turned on again may not be executed. For example, when the spot light 108 is turned on again and subsequently the position of the spot light 108 is moved, it is preferable to execute an operation corresponding to a position at which the spot light 108 is continuously irradiated for a predetermined time period (for example, 1 second) for the first time, after the spot light 108 is turned on. In this manner, operations corresponding to areas, across which the spot light 108 merely traverses, are prevented from being executed.

Further, for example, it is possible that the position at which the spot light 108 is turned on again is placed outside the selection area. In such a case, an operation corresponding to a point within the selection area, at which the spot light 108 stays for the first time after the spot light 108 is turned on, may be performed.

### Third Embodiment

In the above described first and second embodiments, the examples are explained such that the operation for selecting a selection button in the selection area is executed when the light pointer 107 is turned on again. However, as described above, it is possible that the spot light 108 is turned on at a position other than a desired position. Therefore, the operation for selecting a selection button in the selection area may not be executed at a time in which the light pointer 107 is turned on. In this case, similar to the case of displaying the selection area, the operation corresponding to a position, at which the spot light 108 is turned off again after the spot light 108 is turned on again in the selection area, may be executed.

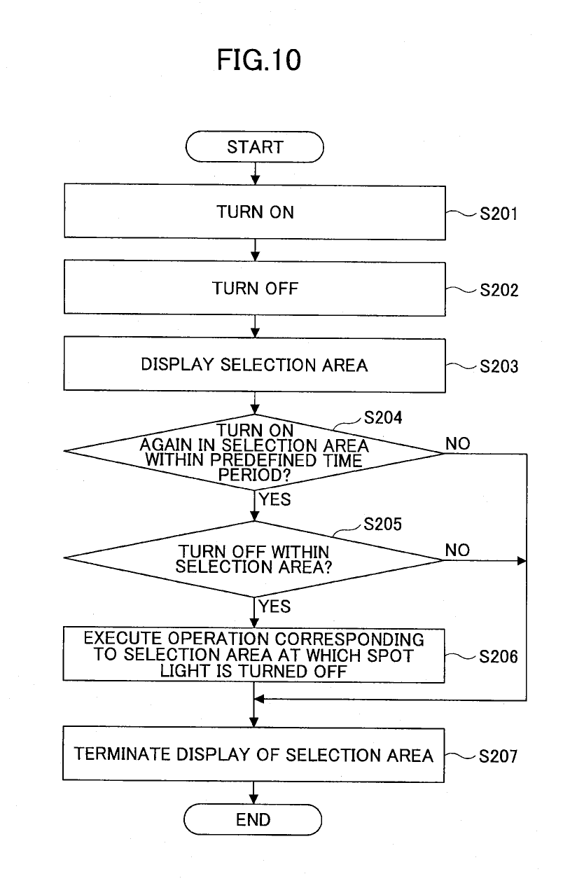

FIG. 10 is a flowchart illustrating display and operation processing of the selection area by the input device 105 in the third embodiment.

First, when the input device 105 is detecting that the light pointer 107 has been turned on (S201) and subsequently detects that the light pointer 107 is turned off (S202), the input device 105 combines the selection area 306 with an original image (S203).

In this state, the input device 105 determines whether the spot light 108 from the light pointer 107 is turned on again in the selection area 306 within a predefined time period (S204). When the input device 105 determines that the spot light 108 is turned on in the selection area 306 (S204: Yes), the input device 105 determines whether the spot light 108 is turned off again in the selection area 306 (S205).

When the input device 105 determines that the spot light 108 is turned off again in the selection area 306 (S205: Yes), the input device 105 executes an operation corresponding to the position at which the spot light 108 is turned off again (S206), and subsequently the display of the selection area is terminated (S207).

On the other hand, when the spot light 108 is turned on again after the predefined time period has passed or the spot light 108 is turned on at outside the selection area 306 (S204: No), or when the spot light 108 is not turned off again in the selection area 306 after the spot light 108 is turned on again in the selection area 306 (S205: No), the display of the selection area 306 is terminated (S207).

In the third embodiment, the operator can select a content of an operation while the light pointer 107 is turned on and the selection area 306 is displayed. Therefore, a content of an operation can be visually selected and the operability of the image display system is further improved.

Further, when the spot light 108 is turned on again in the selection area 306, an operation corresponding to the point at which the spot light 108 is turned on again may be executed, as explained in the first embodiment, and when the spot light 108 is turned on again outside the selection area 306, an operation corresponding to the point in the selection area, at which the spot light 108 is turned off again after the spot light 108 is turned on again, may be executed, as explained in the third embodiment.

### Fourth Embodiment

Further, as described above, the input device 105 may calculate the motion vector of the spot light 108 based on the change trajectory of the coordinates of the spot light 108. In addition, the input device 105 may determine whether a speed of the motion vector is greater than a predetermined speed. When the input device 105 determines that the speed of the motion vector is greater than the predetermined speed and detects that the spot light 108 is turned off, the input device 105 may not display the selection area.

Examples of such a state in which the spot light 108 is moving quickly include a case in which the operator is trying to move the spot light 108 toward outside the image display area 102. In such a case, with the configuration according to the fourth embodiment, it can be prevented that the selection area is unintentionally displayed.

### Fifth Embodiment

In the above described embodiments, the examples are explained such that a function to click a predetermined selection button is executed when the spot light 108 from the light pointer 107 is turned on and/or turned off in the selection area. However, other operations may be executed when the light pointer 107 is turned on and/or turned off.

For example, when the light pointer 107 is turned on and the spot light 108 is moved in an area (non-operational area) other than the areas where the operation buttons are displayed in any of the selection areas shown in FIG. 3B, and in FIGS. 6-8, a drag and drop function of the selection area may be realized by causing the display position of the selection area to be moved. In this manner, the display position of the selection area may be moved to a desired position.

Further, when the spot light 108 from the light pointer 107 is continuously turned on and turned off in a predefined time period in the selection area, a double-click function may be executed. Additionally, for example, when the spot light 108 from the light pointer 107 is continuously turned on and turned off in a predefined time period in the scroll up area 302 or in the scroll down area 305 in the selection area, a continuous scrolling function (a state in which the corresponding area is continuously clicked) may be executed.

The present invention is not limited to the specifically disclosed embodiments, and variations and modifications may be made without departing from the scope of the present invention.

The present application is based on Japanese Priority Application No. 2011-102717, filed on May 2, 2011, the entire contents of which are hereby incorporated herein by reference.

What is claimed is:

1. An image display system comprising:
an image projection unit configured to project image information;
a light pointer configured to designate a point in the image information by irradiating pointing light, wherein the irradiation of the pointing light can be turned on and turned off;
a photographing unit configured to photograph an area on which the image information is projected, and configured to output photographed information;
an instruction detection unit configured to detect an irradiation position of the pointing light in the image information based on the photographed information, and configured to detect whether the irradiation of the pointing light is turned on or turned off; and
a control unit configured to set additional image information at a timing in which the instruction detection unit detects that the irradiation of the pointing light is turned off, depending on a position at which the irradiation of the pointing light is turned off.

2. The image display system according to claim 1,
wherein the additional image information includes at least an operation button for executing a predetermined operation on the image information.

3. The image display system according to claim 2,
wherein, when the instruction detection unit detects that the irradiation of the pointing light is turned on within an area of the operation button, the control unit determines that the operation button is operated.

4. The image display system according to claim 2,
wherein, when the instruction detection unit detects that the irradiation of the pointing light is turned on and determines whether the irradiation of the pointing light is within an area of the operation button, and subsequently a point within the area is continuously irradiated by the pointing light for a predetermined time period, the control unit determines that the operation button is operated.

5. The image display system according to claim 2,
wherein, when the instruction detection unit detects that the irradiation of the pointing light is turned on within an area other than an area of the operation button, and subsequently the instruction detection unit detects that the irradiation of the pointing light is turned on or turned off within the area of the operation button, the control unit determines that the operation button is operated.

6. The image display system according to claim 2,
wherein, when the instruction detection unit detects that the irradiation of the pointing light is turned off again within an area of the operation button, the control unit determines that the operation button is operated.

7. The image display system according to claim 1,
wherein, when the instruction detection unit detects that the irradiation of the pointing light is turned off within a boundary region, the control unit does not set the additional image information.

8. The image display system according to claim 2,
wherein the additional image information includes a non-operational area, on which the operation button is not displayed,
wherein the control unit calculates a change trajectory of the irradiation position of the pointing light, based on the irradiation position of the pointing light detected by the instruction detection unit, and
wherein, when the instruction detection unit detects that the irradiation of the pointing light is turned on in the non-operation area, the control unit varies a setting position of the additional image information along the change trajectory of the irradiation position of the pointing light.

9. The image display system according to claim 1,
wherein the control unit calculates a change trajectory of the irradiation position of the pointing light, based on the irradiation position of the pointing light detected by the instruction detection unit, and the control unit calculates a motion vector quantity of the pointing light, based on the change trajectory of the irradiation position of the pointing light,
wherein the control unit determines whether a speed determined by the motion vector quantity is greater than a predetermined speed, and
wherein, when the control unit determines that the speed determined by the motion vector quantity is greater than the predetermined speed, and the instruction detection unit detects that the irradiation of the pointing light is turned off, the control unit does not set the additional image information.

10. An image display method comprising:
an image projection step of projecting image information;
a pointing step, by a light pointer, wherein the light pointer designates a point in the image information by irradiating pointing light, and the irradiation of the pointing light can be turned on and turned off;
a photographing step of photographing an area on which the image information is projected, and outputting photographed information;
an instruction detecting step of detecting an irradiation position of the pointing light in the image information based on the photographed information, and detecting whether the irradiation of the pointing light is turned on or turned off; and
a display control step of setting additional image information at a timing in which the instruction detection step detects that the irradiation of the pointing light is turned off, depending on a position at which the irradiation of the pointing light is turned off.
